(19) United States
(12) Patent Application Publication
(10) Pub. No.: US 2009/0117975 A1
(43) Pub. Date: May 7, 2009

(54) GAMING MACHINE WITH SYMBOL CHANGED ACCORDING TO PREDETERMINED CONDITIONS AFTER REARRANGEMENT AND PLAYING METHOD THEREOF

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp, Tokyo (JP)

(21) Appl. No.: 12/029,718

(22) Filed: Feb. 12, 2008

Related U.S. Application Data
(60) Provisional application No. 60/984,516, filed on Nov. 1, 2007.

(51) Int. Cl. A63F 13/00

(52) U.S. Cl. 463/20

(57) ABSTRACT

A slot machine of the present invention has a display on which symbols are rearranged in partitioned regions formed in a matrix shape by a plurality of columns and a plurality of rows. Then, in each unit game, when a symbol sandwiched by two “Special” symbols exists among symbols rearranged in the partitioned regions, a display content of the display is changed such that that symbol is changed to the “Special” symbol before a start of a next unit game. In this way, the number of “Special” symbols rearranged on the display is increased more than the number at a stage immediately after the rearrangement. By this increase of the “Special” symbols, it becomes possible for a player to receive a payout of credit in a large payout amount in the unit game.

### CROSS REFERENCE TO RELATED APPLICATIONS

This application claims priority to co-pending U.S. provisional patent application Ser. No. 60/984,516 filed on Nov. 1, 2007, and which is incorporated by reference herein for all purposes.

### BACKGROUND OF THE INVENTION

1. Field of the Invention

The present invention relates to a gaming machine such as a personal computer installed with a slot machine and a game program in which a rearrangement of a symbol arranged in each of a plurality of partitioned regions that are arranged in a matrix shape formed by a plurality of columns and a plurality of rows is carried out on a display in each unit game, and a playing method thereof.

2. Description of the Related Art

In a slot machine which is one of the representative related gaming machines, when a player inserts a prescribed number of medals into a medal insertion slot and operates a start button, each one of a plurality (three, for example) of reels on which a plurality of symbols are drawn is rotated individually, in a unit game. After that, the reels are stopped when a prescribed period of time has elapsed. At that point, if symbols that constitute a winning combination are stopped on a payline set up in advance or a prescribed number of scatter symbols are stopped, a payout according to a number of medals inserted is generated.

On the other hand, the specification of U.S. Patent Application Publication No. 2002/0025843 describes a game in which a rearrangement of a plurality (fifteen, for example) of symbols is carried out by displaying an image of a plurality (five, for example) of reels and an image for effects on a single display and carrying out a dynamically changing display in which these displayed reels are rotated, in a unit game.

As such, in a related slot machine, when a plurality of symbols are rearranged, a content of the payout is uniquely determined according to a content of each of these rearranged symbols, in a unit game.

In view of such a related slot machine, there are demands for an appearance of a slot machine that has a new entertainment quality.

### SUMMARY OF THE INVENTION

The present invention has an object to provide a gaming machine and a playing method thereof, which are capable of providing a new entertainment quality in a gaming machine in which a rearrangement of a symbol arranged in each of a plurality of partitioned regions which are arranged in a matrix shape formed by a plurality of columns and a plurality of rows is carried out on a display in each unit game.

The first aspect of the present invention is a gaming machine comprising: a display on which a rearrangement of symbols arranged in a plurality of partitioned regions that are arranged in a matrix shape formed by a plurality of columns and a plurality of rows is carried out in each unit game; and a controller configured to (a) rearrange the symbols in the plurality of partitioned regions in a unit game, and (b) when both of symbols at both ends of a symbol sequence formed by a plurality of symbols rearranged along one of a column direction, a row direction, and an oblique direction composed from the column direction and the row direction are prescribed symbols, change all symbols sandwiched by the prescribed symbols in the symbol sequence to the prescribed symbols before a start of a next unit game.

The second aspect of the present invention is a gaming machine comprising: a display on which a rearrangement of symbols arranged in a plurality of partitioned regions is carried out in each unit game, by a video display of a liquid crystal display which is provided over the plurality of partitioned regions that are arranged in a matrix shape formed by a plurality of columns and a plurality of rows; and a controller configured to (a) rearrange the symbols in the plurality of partitioned regions by changing a content of the video display, in a unit game, and (b) when both of symbols at both ends of a symbol sequence formed by a plurality of symbols rearranged along one of a column direction, a row direction, and an oblique direction composed from the column direction and the row direction are prescribed symbols, change all symbols sandwiched by the prescribed symbols in the symbol sequence to the prescribed symbols by changing a content of the video display, before a start of a next unit game.

The third aspect of the present invention is a gaming machine comprising: a display on which a rearrangement of symbols arranged in a plurality of partitioned regions that are arranged in a matrix shape formed by a plurality of columns and a plurality of rows is carried out in each unit game, by rotation and stopping of a plurality of mechanical reels corresponding to the plurality of columns and the plurality of rows; and a controller configured to (a) rearrange the symbols in the plurality of partitioned regions by rotation and stopping of the mechanical reels, in a unit game, and (b) when both of symbols at both ends of a symbol sequence formed by a plurality of symbols rearranged along one of a column direction, a row direction, and an oblique direction composed from the column direction and the row direction are prescribed symbols, change all symbols sandwiched by the prescribed symbols in the symbol sequence to the prescribed symbols by rotation and stopping of the mechanical reels corresponding to partitioned regions in which the symbols sandwiched by the prescribed symbols in the symbol sequence are rearranged, before a start of a next unit game.

The fourth aspect of the present invention is a method of playing a gaming machine, the method comprising the steps of: rearranging symbols in a plurality of partitioned regions that are arranged in a matrix shape formed by a plurality of columns and a plurality of rows, in each unit game; and when both of symbols at both ends of a symbol sequence formed by a plurality of symbols rearranged along one of a column direction, a row direction, and an oblique direction composed from the column direction and the row direction are prescribed symbols, changing all symbols sandwiched by the prescribed symbols in the symbol sequence to the prescribed symbols before a start of a next unit game.

### BRIEF DESCRIPTION OF THE DRAWINGS

FIG. 1A is an explanatory diagram showing an exemplary display to be displayed on a liquid crystal display of a slot machine according to the first embodiment of the present invention.

FIG. 1B is an explanatory diagram showing an exemplary display to be displayed on a liquid crystal display of a slot machine according to the first embodiment of the present invention.

FIG. 2 is an explanatory diagram showing partitioned regions in a matrix shape that are provided on a display of a slot machine according to the first embodiment of the present invention.

FIG. 3 is a perspective view of a slot machine according to the first embodiment of the present invention.

FIG. 4 is a block diagram showing a control circuit of a slot machine according to the first embodiment of the present invention.

FIG. 5 is a diagram showing a payout table used in a slot machine according to the first embodiment of the present invention.

FIG. 6 is a flow chart showing a processing procedure of a slot machine according to the first embodiment of the present invention.

FIG. 7 is an explanatory diagram showing an exemplary display of a slot game to be executed on a display of a slot machine according to the first embodiment of the present invention.

FIG. 8 is an explanatory diagram showing an exemplary display of a slot game to be executed on a display of a slot machine according to the first embodiment of the present invention.

FIG. 9 is an explanatory diagram showing an exemplary display of a slot game to be executed on a display of a slot machine according to the first embodiment of the present invention.

FIG. 10 is an explanatory diagram showing an exemplary display of a slot game to be executed on a display of a slot machine according to the first embodiment of the present invention.

FIG. 11 is an explanatory diagram showing an exemplary display of a slot game to be executed on a display of a slot machine according to the first embodiment of the present invention.

FIG. 12 is an explanatory diagram showing an exemplary display of a slot game to be executed on a display of a slot machine according to a modification of the first embodiment of the present invention.

FIG. 13 is an explanatory diagram showing an exemplary display of a slot game to be executed on a display of a slot machine according to a modification of the first embodiment of the present invention.

FIG. 14 is an explanatory diagram showing an exemplary display of a slot game to be executed on a display of a slot machine according to a modification of the first embodiment of the present invention.

FIG. 15 is an explanatory diagram showing an exemplary display of a slot game to be executed on a display of a slot machine according to a modification of the first embodiment of the present invention.

FIG. 16 is a perspective view of a slot machine according to the second embodiment of the present invention.

FIG. 17A is a perspective view showing a rotation reel device of a slot machine according to the second embodiment of the present invention.

FIG. 17B is a side view showing a rotation reel device of a slot machine according to the second embodiment of the present invention.

FIG. 18 is an explanatory diagram showing a schematic configuration of symbols arranged on circumferential faces of rotation reels of a slot machine according to the second embodiment of the present invention.

FIG. 19 is a block diagram showing a control circuit of a slot machine according to the second embodiment of the present invention.

FIG. 20 is an explanatory diagram showing a schematic configuration of a gaming system according to the third embodiment of the present invention.

### DETAILED DESCRIPTION OF THE EMBODIMENTS

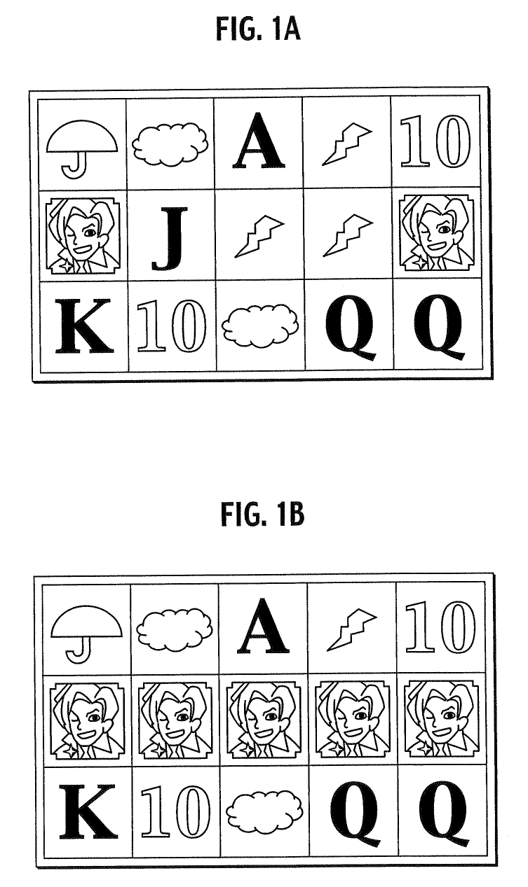

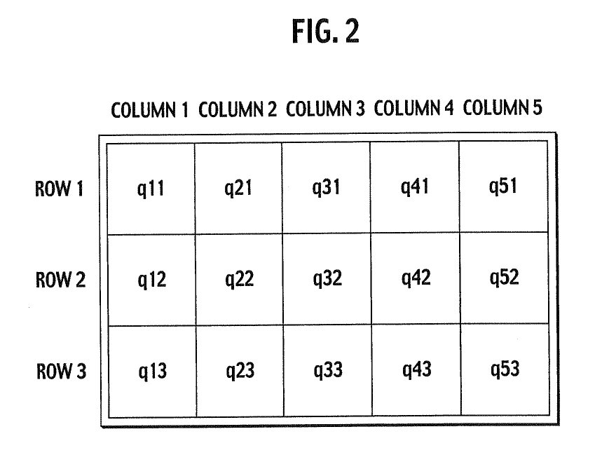

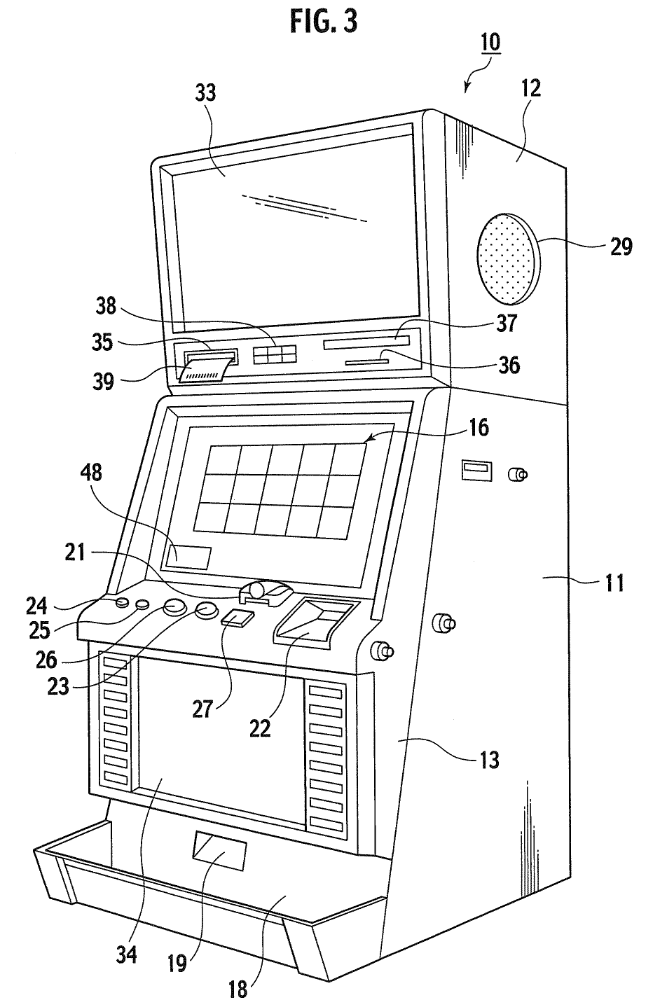

In the following, an operation of a slot machine which is an example of a gaming machine according to the present invention and an outline of its playing method will be described with references to FIG. 1A, FIG. 1B, FIG. 2 and FIG. 3. FIG. 1A and FIG. 1B are explanatory diagrams showing exemplary displays to be displayed on a display of a slot machine according to one example of the present invention. FIG. 2 is an explanatory diagram showing partitioned regions in a matrix shape that are provided on a display of a slot machine according to one example of the present invention. FIG. 3 is a perspective view of a slot machine according to one example of the present invention.

A display 16 shown in FIG. 1A (corresponding to a display of the present invention) is provided on a front face of a cabinet 11 of a slot machine 10 shown in FIG. 3. This display 16 has 15 partitioned regions q11 to q53 as shown in FIG. 2. These partitioned regions q11 to q53 are arranged in a matrix shape formed by first to fifth columns and first to third rows.

In the slot machine 10 of FIG. 3 according to one example of the present invention, symbols arranged in the partitioned regions q11 to q53 of FIG. 2 described above are rearranged each time a unit game is executed. A symbol rearranged in each of the partitioned regions q11 to q53 is going to be one of eight types of symbols shown in FIG. 1A including “A (Ace card)”, “K (King card)”, “Q (Queen card)”, “J (Jack card)”, “10 (10 card)”, “Umbrella”, “Lightning”, and “Cloud”, for example.

However, a symbol rearranged in some of the partitioned regions, such as partitioned regions q11 to q13 and q51 to q53 on the first and fifth columns located at two ends in the row direction of FIG. 2, is going to be one of nine types of symbols in which a symbol “Special (man's face in this embodiment)” shown in FIG. 1A is added to the eight types of symbols described above.

Then, when the symbols are rearranged in the partitioned regions q11 to q53 in a unit game, a payout credit amount (an award) is determined according to predetermined rules of a payout table, and a payout of credit (an award) in the determined payout amount is made. After that, as a next unit game is started, the symbols of the partitioned regions q11 to q53 will be rearranged.

Now, depending on contents of the symbols rearranged in the partitioned regions q11 to q53 in a unit game, there are cases where symbols other than “Special” rearranged in the partitioned regions q22, q32 and q42 on the second to fourth columns are sandwiched by two “Special” symbols rearranged in the partitioned region q12 on the first column and the partitioned region q52 on the fifth column, as shown in FIG. 1A, for example.

In such cases, the symbols in the partitioned regions q22, q32 and q42 which are sandwiched by two “Special” symbols will be changed to “Special” symbols as shown in FIG. 1B, before they are rearranged by a next unit game. Then, in that unit game, a payout credit amount corresponding to a case of having five “Special” symbols rearranged will be determined according to the predetermined rules of the payout table, and the payout of credit in the determined payout amount will be made.

According to the slot machine and its playing method according to such an example of the present invention, in a unit game, if the symbols are rearranged in the partitioned regions q11 to q53 such that the symbols rearranged in the partitioned regions q22, q32 and q42 on the second to fourth columns are sandwiched by two “Special” symbols in the partitioned region q12 on the first column and the partitioned region q52 on the fifth column, as shown in FIG. 1A, for example, a result of this unit game is not ascertained at that point.

Then, when the symbols in the partitioned regions q22, q32 and q42 which are sandwiched by two “Special” symbols are changed to “Special” symbols as shown in FIG. 1B, a result of this unit game is ascertained.

Consequently, it is possible to make a novel effect display filled with hereto unavailable changes in such a manner that there are cases where the result of this unit game is not yet ascertained even when the symbols are rearranged in the partitioned regions q11 to q53 of the display 16, depending on their contents, and the result of the unit game will be ascertained after the rearranged contents of some of symbols are changed. In this way, it becomes possible to provide a new entertainment quality in the gaming machine and its playing method.

Note that the symbols for sandwiching symbols other than “Special” may be either two “Special” symbols with an interval in the row direction as shown in FIG. 1A, or two “Special” symbols with an interval in the column direction. They may also be two “Special” symbols with an interval in an oblique direction composed from the column direction and the row direction (a direction intersecting with each of the column direction and the row direction at 45°).

In addition, in the case where symbols other than “Special” are sandwiched by two “Special” symbols, it is also possible to determine the payout credit amount to be paid in that unit game according to the rearranged contents of the symbols after changing these symbols other than “Special” to “Special” symbols, and it is also possible to determine the payout credit amount to be paid in that unit game according to the rearranged contents of the symbols after the change, before changing these symbols other than “Special” to “Special” symbols, on an assumption that they will be changed later.

Next, the detail of the slot machine according to the first embodiment of the present invention will be described. As shown in FIG. 3, the slot machine 10 of this embodiment has the cabinet 11, a top box 12 arranged on an upper side of the cabinet 11, and a main door 13 provided on a front face of the cabinet 11. On a front side of the main door 13, the display 16 is provided. This display 16 has the 15 partitioned regions q11 to q53 arranged in a matrix shape formed by first to fifth columns and first to third rows as shown in FIG. 2. Also, the display 16 has a liquid crystal panel, and this liquid crystal panel displays symbols to be rearranged in the partitioned regions q11 to q53 of the display 16 by a content change of a video display of the liquid crystal panel.

Note that, in this embodiment, an exemplary case of using medals as the gaming medium to be used at a time of executing a game is described, but the gaming medium is not limited to the medals, and can be medals, tokens, electronic money, or electronic value information (credit) corresponding to these.

On the lower side of the display 16, various types of input buttons 23 to 27 through which commands related to the proceeding of the game will be inputted by a player, a medal insertion slot 21 for accepting medals, and a bill validator 22 for checking the validity of bills and accepting valid bills are provided. Note that the bill validator 22 may be configured such that it can read a bar code attached ticket 39.

Also, in a vicinity of these medal insertion slot 21 and bill validator 22, various types of operation switches are provided. As the operation switches, a payout switch 23, a MAXBET switch 24, a BET switch 25, a spin repeat bet switch 26, and a start switch 27 are provided.

The BET switch 25 is a switch for determining the credit amount to be bet with respect to the slot game (unit game) to be executed on the display 16, where the credit of one medal will be bet every time the BET switch 25 is pressed, as will be described below.

The spin repeat bet switch 26 is for executing the slot game by betting the credit again without changing the credit amount bet by the BET switch 25 described above in a previous game.

The start switch 27 is a switch for starting the slot game after the desired amount of credit is bet. When this start switch 27 is pressed after either medals are inserted into the medal insertion slot 21 or the credit is bet by the BET switch 25, the slot game will be started on the display 16.

The payout switch 23 is a switch for having the inserted medals paid out, and the medals to be paid will be ejected from a medal payout opening 19 that is opening at a lower front side of the main door 13, and the paid medals will be accumulated in a medal tray 18.

The MAXBET switch 24 is a switch for betting the maximum amount of credit (30 medals, for example) that can be bet in one game, by a single operation.

On the lower front face of the main door 13, a foot display 34 is provided, which displays a prescribed image according to an image display control data contained in a currently executed game software. This image can be a character of the slot machine 10 or the like, for example.

On a front face of the top box 12, an upper display 33 is provided. The upper display 33 has a liquid crystal panel, which displays the payout table and the like.

Also, on the top box 12, a speaker 29 is provided. On a lower side of the upper display 33, a ticket printer 35, a card reader 36, a data display 37, and a key pad 38 are provided. The ticket printer 35 prints a bar code, in which data such as the credit amount, the date and time, the identification number of the slot machine 10, etc. are encoded, on a ticket, and outputs it as the bar code attached ticket 39.

A player can play a game on this slot machine by having the bar code attached ticket 39 read at another slot machine, or exchange the bar code attached ticket 39 to bills and the like at a prescribed location in a gaming facility (a cashier in the casino, for example).

The card reader 36 is capable of having a smart card inserted therein, and carrying out a reading of data from the inserted smart card and a writing of data into the smart card. The smart card is a card to be carried around by a player, which stores data for identifying a player and data regarding a log of games played by a player.

The smart card may also store data corresponding to coins, bills, or credit. Also, instead of the smart card, a magnetic stripe card may be adopted. The data display 37 is formed by a fluorescent display or the like, and displays data read by the card reader 36 and data inputted by a player through the key pad 38, for example.

Also, instead of the smart card, an RFID scheme may be adopted and a card to/from which data can be written/read in a non-contact manner may be used. The key pad 38 is for inputting commands and data regarding a ticket issuance and the like.

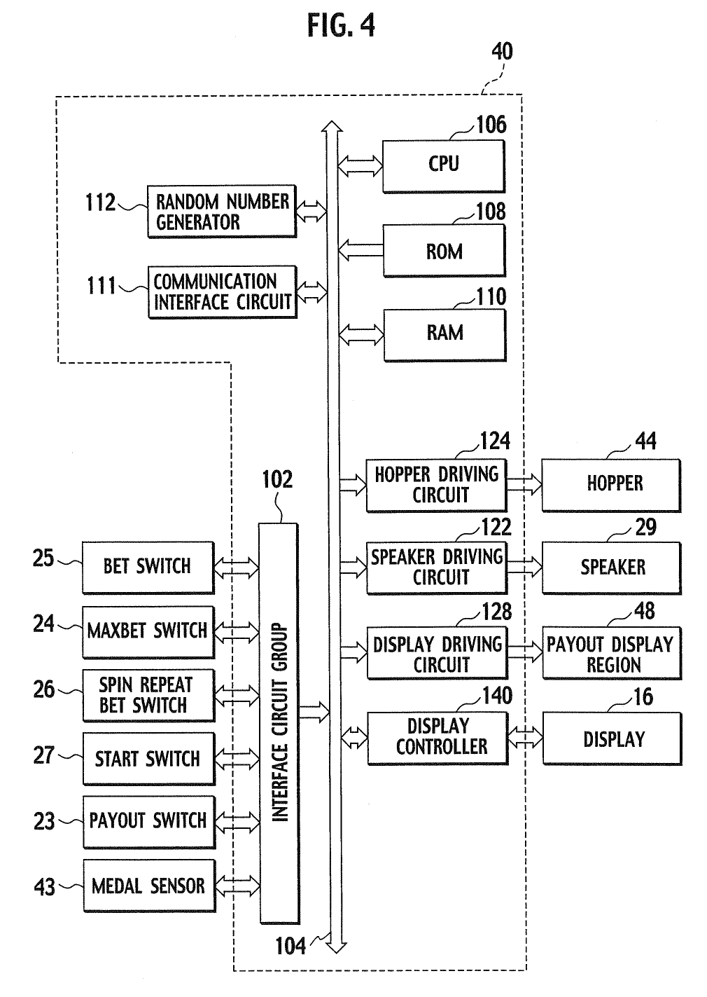

FIG. 4 is a block diagram showing a control circuit of the slot machine according to this embodiment. In the figure, a controller 40 is a micro-computer, which has an interface circuit group 102, an input/output bus 104, a CPU 106, a ROM 108, a RAM 110, a communication interface circuit 111, a random number generator 112, a speaker driving circuit 122, a hopper driving circuit 124, a display driving circuit 128, and a display controller 140.

The interface circuit group 102 is connected to the input/output bus 104, and this input/output bus 104 carries out input/output of data signals or address signals with respect to the CPU 106.

To the interface circuit group 102, the start switch 27 is connected. A start signal outputted from this start switch 27 is converted into a prescribed signal at the interface circuit group 102, and then transmitted to the CPU 106 through the input/output bus 104.

In addition, to the interface circuit group 102, the BET switch 25, the MAXBET switch 24, the spin repeat bet switch 26 and the payout switch 23 are connected. Then, the switching signals outputted from these switches 25, 24, 26 and 23 are supplied to the interface circuit group 102, converted into prescribed signals at this interface circuit group 102, and then transmitted to the CPU 106 through the input/output bus 104.

Moreover, to the interface circuit group 102, a medal sensor 43 is connected. The medal sensor 43 is a sensor for detecting medals inserted at the medal insertion slot 21, which is provided at a medal insertion portion of the medal insertion slot 21. A detection signal outputted from this medal sensor 43 is supplied to the interface circuit group 102, converted into a prescribed signal at this interface circuit group 102, and then transmitted to the CPU 106 through the input/output bus 104.

To the input/output bus 104, the ROM 108 for storing a system program and the RAM 110 for storing various types of data are connected. In the RAM 110, areas and the like for managing flags and storing various types of information are provided.

In the ROM 108, the payout table is stored. The payout table indicates a condition for generating the payout, and its correspondence relationship with the credit payout amount in the case where this condition is satisfied. The condition for generating the payout is indicated by symbols stopped at some of the partitioned regions q11 to q53 of the display 16, that is the stopped symbols, and a number of these stopped symbols. In the slot game of this embodiment, the CPU 106 determines whether or not to generate the payout (whether or not to make the credit payout) and the credit payout amount (an amount of credit to be paid), according to the payout table and the symbols stopped at the partitioned regions q11 to q53.

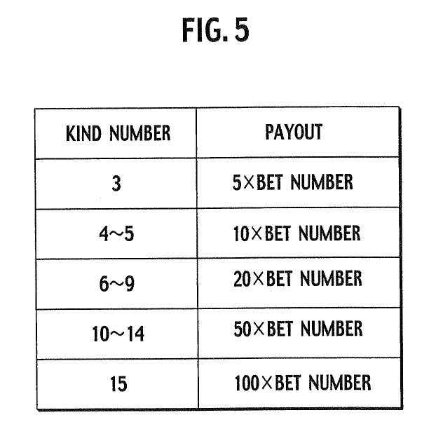

FIG. 5 is an explanatory diagram showing the payout table regarding “Special” symbols stored in the ROM 108. As shown in FIG. 5, when a number of “Special” symbols rearranged in the partitioned regions q11 to q53 (a KIND number) is “3”, the payout is 5× bet credit amount. The payout will be 10× bet credit amount when the number of symbols is “4 to 5”, 20× bet credit amount when the number of symbols is “6 to 9”, 50× bet credit amount when the number of symbols is “10 to 14”, and 100× bet credit amount when the number of symbols is “15”.

In this way, in the slot machine 10 of this embodiment, the payout is determined according to a type of symbols and their number which are stopped at the partitioned regions q11 to q53, rather than generating the payout when a winning combination is realized on a payline set up on the display 16.

Also, in the ROM 108, for each of the partitioned regions q11 to q53, a correspondence relationship between a code number indicating each symbol and one or a plurality of random numbers belonging to a prescribed numerical value range (0 to 255) is stored as a weight data. For example, for a certain symbol, when a plurality of random numbers corresponding to that symbol are set, a probability for that symbol to get selected becomes higher compared with a case of having one random number set.

Note that, in this embodiment, the weight data are stored in the ROM 108 for each of the partitioned regions q11 to q53. In particular, a plurality of weight data are stored in the ROM 108 for the partitioned regions q11 to q13 and q51 to q53 on the first and fifth columns, and normally one default weight data among them will be used at a time of determining symbols to be rearranged in the partitioned regions q11 to q13 and q51 to q53 on the first and fifth columns.

The CPU 106 reads out a game execution program from the ROM 108 and executes the game, at a timing when a start operation of the game is accepted by the start switch 27. The game execution program is a program for executing the slot game on the display 16 through the display controller 140.

Namely, as a program for executing the slot game, the game execution program is programmed to execute the slot game such that symbols are displayed as dynamically changing simultaneously in the partitioned regions q11 to q53 of the display 16, and then symbols are stopped, and the credit of the payout amount according to the payout table stored in the ROM 108 is paid when symbols in contents which are a target for generating the payout are rearranged.

In addition, to the input/output bus 104, the random number generator 112, the communication interface circuit 111, the display controller 140, the hopper driving circuit 124, the speaker driving circuit 122, and the display driving circuit 128 are connected.

The communication interface circuit 111 is connected to a hall server or the like, and transmits data on a play log executed at this slot machine 10 and the like to the hall server. It also receives various types of data transmitted from the hall server.

The random number generator 112 generates a random number for determining whether or not to generate a winning combination or a jackpot in the slot game executed on the display 16.

The display driving circuit 128 carries out a control for displaying the payout amount on a payout display region 48 provided on a lower left region of the display 16.

The speaker driving circuit 122 outputs speech data to the speaker 29. Namely, the CPU 106 reads out the speech data stored in the ROM 108, and transmit this speech data to the speaker driving circuit 122 through the input/output bus 104. In this way, a prescribed effect sound will be generated from the speaker 29.

The hopper driving circuit 124 outputs a payout signal to the hopper 44 when the payout is generated. Namely, when a payout signal is inputted by the payout switch 23, the CPU 106 outputs a driving signal to the hopper driving circuit 124 through the input/output bus 104. In this way, the hopper 44 pays medals corresponding to the remaining amount of credit at that moment which is stored in a prescribed memory region of the RAM 110.

The display controller 140 carries out a display control for executing the effects according the slot game and the game result of the slot game. Namely, the CPU 106 generates an image display command signal according to a state of the slot game and a result of the slot game, and outputs this image display command signals to the display controller 140 through the input/output bus 104.

When the image display command signal outputted from the CPU 106 is inputted, the display controller 140 generates a driving signal for driving the display 16 according to this image display command, and outputs this generated driving signal to the display 16. In this way, an effect screen according to the slot game and its result will be displayed on the display 16.

The CPU 106 outputs the image display command for displaying an image of the slot game and an effect image according to its result on the display 16 to the display controller 140 at a timing according to a progress of the slot game. In this way, the effects according to the slot game and its game result will be made on the display 16.

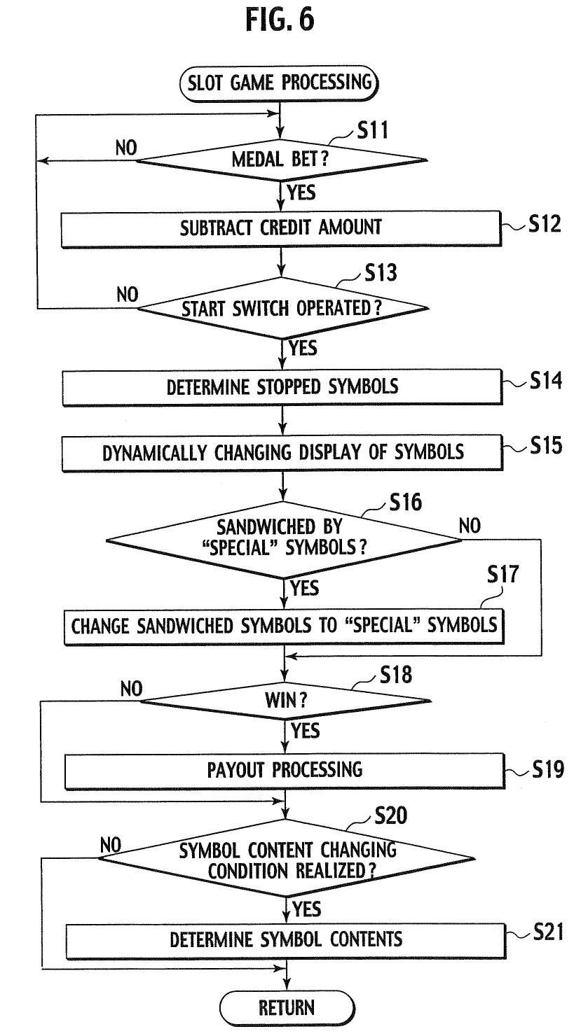

Next, with reference to the flow chart shown in FIG. 6, the operation of the slot machine according to this embodiment will be described. FIG. 6 is a flow chart showing a procedure of the slot game processing to be carried out by the CPU 106 shown in FIG. 4 according to the game execution program stored in the ROM 108.

First, when it is entered into the slot game processing shown in FIG. 6, the CPU 106 judges whether the credit is bet or not at the step S11. In this processing, the CPU 106 judges whether or not either a signal outputted from the BET switch 25 as the BET switch 25 is pressed or a signal outputted from the MAXBET switch 24 as the MAXBET switch 24 is pressed is received. When it is judged that the credit is not bet, the processing is returned to the step S11.

On the other hand, when it is judged that the credit is bet at the step S11, the CPU 106 proceeds to the step S12, and subtracts the credit amount stored in the RAM 11 according to the bet credit amount.

Next, at the step S13, the CPU 106 judges whether the start switch 27 is pressed or not. In this processing, the CPU 106 judges whether or not a signal outputted from the start switch 27 as the start switch 27 is pressed is received.

When it is judged that the start switch 27 is not pressed, the CPU 106 returns the processing to the step S11. Note that, when the start switch 27 is not pressed (a case where a command for finishing the game is inputted without pressing the start switch 27, for example), the CPU 106 cancels the subtraction result of the credit amount at the step S12.

Then, when it is judged that the start switch 27 is pressed at the step S13, the CPU 106 proceeds from the step S13 to the step S14, and determines the stopped symbols. In this stopped symbol determination processing, the CPU 106 determines symbols to be displayed as stopping (rearranged) in the display regions q11 to q53 by executing a stopped symbol determination program which is one of the game execution program stored in the ROM 108.

In this processing, the CPU 106 selects a random number from numerical values of “0 to 255” for each of the display regions q11 to q53 by executing a random number generation program, and determines a stopped symbol for each of the display regions q11 to q53 by referring to a correspondence between a random number and a symbol stored in the ROM 108.

By this stopped symbol determination processing, a symbol to be rearranged in each of the partitioned regions q11 to q13 and q51 to q53 on the first and fifth columns shown in FIG. 2 is determined to be one of nine types of symbols shown in FIG. 1A including “A (Ace card)”, “K (King card)”, “Q (Queen card)”, “J (Jack card)”, “10 (10 card)”, “Umbrella”, “Lightning”, “Cloud”, and “Special (man's face)”.

Also, by this stopped symbol determination processing, a symbol to be rearranged in each of the partitioned regions q21 to q43 on the second to fourth columns shown in FIG. 2 is determined to be one of eight types of symbols I which “Special (man's face)” is excluded from nine types of symbols described above.

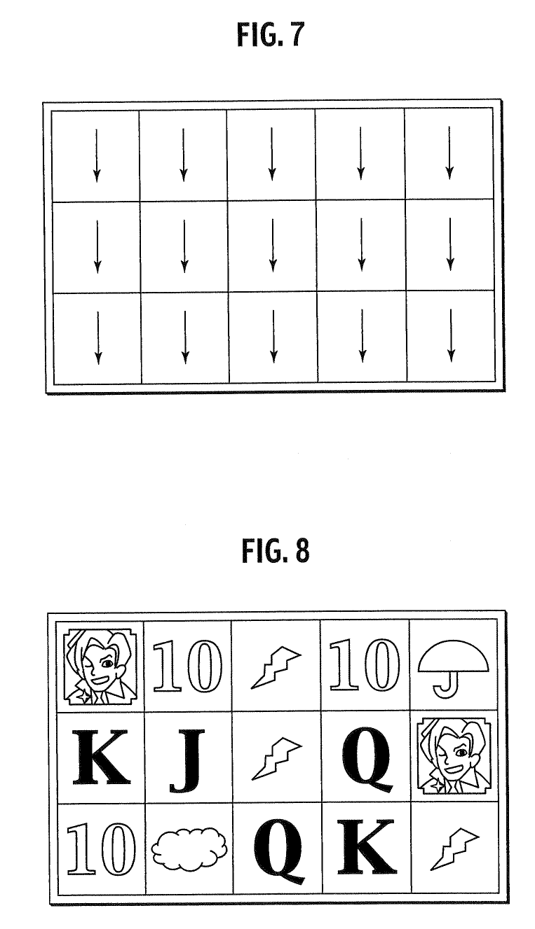

Next, the CPU 106 carries out the symbol dynamically changing display processing at the step S15. This processing is a processing for displaying symbols as dynamically changing in the display regions q11 to q53 as shown in FIG. 7, and then stopping them. By this processing for starting and stopping the dynamically changing display, symbols are rearranged in the display regions q11 to q53.

When the dynamically changing display processing is finished, the CPU 106 proceeds to the step S16, and judges whether “Special” symbols are rearranged in the partitioned regions q11 to q13 and q51 to q53 on the first and fifth columns so as to sandwich symbols rearranged in the partitioned regions q21 to q43 on the second to fourth columns or not.

Namely, the CPU 106 judges whether the symbols rearranged in the partitioned regions q21 to q43 on the second to fourth columns are sandwiched by the “Special” symbols in the partitioned regions q11 to q13 on the first column and the “Special” symbols in the partitioned regions q51 to q53 on the fifth column as shown in FIG. 1A or not.

Then, when the symbols rearranged in the partitioned regions q21 to q43 on the second to fourth columns are not sandwiched by two “Special” symbols rearranged in the partitioned regions q11 to q13 and q51 to q53 on the first and fifth columns as shown in FIG. 8, the processing proceeds to the step S18 to be described below.

On the other hand, when the symbols rearranged in the partitioned regions q21 to q43 on the second to fourth columns are sandwiched by two “Special” symbols rearranged in the partitioned regions q11 to q13 and q51 to q53 on the first and fifth columns, the display content of the display 16 is changed such that the symbols rearranged in the partitioned regions q21 to q43 on the second to fourth columns which are sandwiched by the “Special” symbols are changed to “Special” symbols.

For example, when the symbols rearranged in the partitioned regions q22, q32 and q42 on the second to fourth columns are sandwiched by two “Special” symbols rearranged in the partitioned region q12 on the first column and the partitioned region q52 on the fifth column, as shown in FIG. 1A, the display content of the display 16 is changed at the step S17 such that the symbols in the partitioned regions q22, q32 and q42 are changed to “Special” symbols as shown in FIG. 1B. After that, the processing proceeds to the step S18.

At the step S18, the CPU 106 judges whether there is a win or not according to the symbols rearranged in the partitioned regions q11 to q53. Namely, the CPU 106 judges whether a condition for generating a prize is satisfied or not.

In this step S18, the CPU 106 judges whether or not the symbols rearranged at the step S15 described above or the symbols after changing some of the symbols to “Special” symbols at the subsequent step S17 are coinciding with any of combinations of a type and a number set in the payout table stored in the ROM 108, by referring to the payout table shown in FIG. 5.

Then, when they coincide with a combination of a type and a number set in the payout table, the credit payout amount is determined to be the payout amount set in correspondence to that combination of a type and a number by regarding that a win is realized, and it proceeds from the step S18 to the next step S19. Note that the symbols after changing some of the symbols to “Special” symbols at the step S17 always correspond to one of combinations of a type and a number set in the payout table shown in FIG. 5.

On the other hand, when a number of symbols of the same type and their type among the symbols stopped at the step S15 described above do not coincide with any of the combinations of a type and a number set in the payout table, the CPU106 proceeds the processing to the step S20 to be described below by regarding that a win is not realized.

At the step S19, the CPU 106 executes a payout processing for paying the credit according to a result of the win at the step S18 described above. In this payout processing, the CPU 108 adds the credit payout amount generated at the step S18 described above to the credit amount stored in the RAM 110.

At the step S20, the CPU 106 judges whether a symbol content changing condition is realized or not. This symbol content changing condition may be realized by a winning of a lottery to be carried out as the CPU 106 executes the random number generation program while executing the slot game. Else, it may be realized in a case where the contents of the rearranged symbols in the partitioned regions q11 to q53 are contents that satisfy a certain condition stored in the ROM 108, for example, which is separate from the setting regarding the credit payout amount set in the payout table. Of course, without being limited to these, any other factors may be adopted as the symbol content changing condition.

Then, when the symbol content changing condition is not realized, it is returned to the step S11 described above, and the next slot game processing will be executed. When the symbol content changing condition is satisfied, the CPU 106 carries out a symbol changing content determination processing for determining contents after the change of the symbols in the partitioned regions q11 to q13 and q51 to q53 on the first and fifth columns at the step S21.

In this step S21, the CPU 106 changes the weighting data in the ROM 108 corresponding to the partitioned regions q11 to q13 and q51 to q53 on the first and fifth columns from the default weighting data to the other weighting data. Then, rearrangement candidate symbols for which a frequency of appearance of each type of symbol is different in proportion to a level of a probability for being rearranged in the partitioned regions q11 to q13 and q51 to q53 on the first and fifth columns will be displayed (as notification images) in the partitioned regions q11 to q13 and q51 to q53 on the first and fifth columns, according to the weighting data after the change.

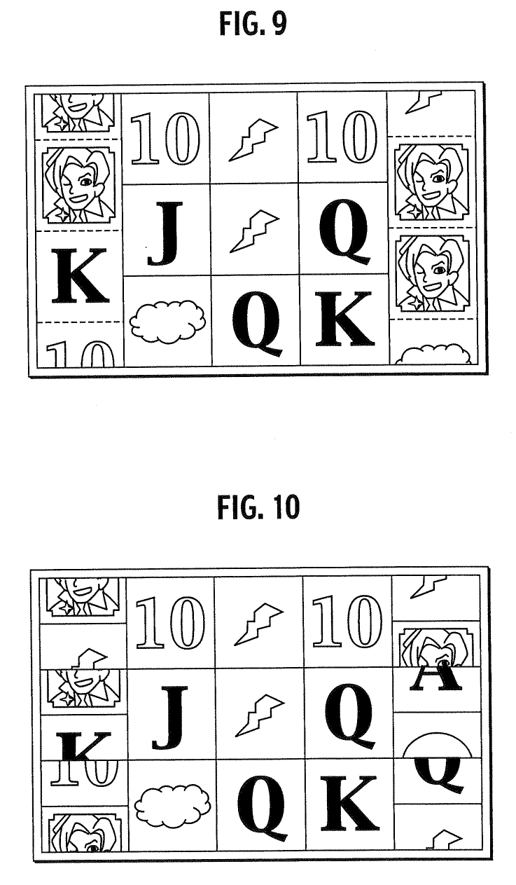

The rearrangement candidate symbols after changing the weighting data can be displayed on the display 16 in forms of rotation reels straddling over the partitioned regions q11 to q13 on the first column and the partitioned regions q51 to q53 on the fifth column, as shown in FIG. 9, for example.

Else, for each of the partitioned regions q11 to q13 and q51 to q53 on the first and fifth columns, a rearrangement candidate symbol can be displayed in a form of being scrolled up or down, for example, sequentially in each of the partitioned regions q11 to q13 and q51 to q53 on the first and fifth columns of the display 16, as shown in FIG. 10.

After this symbol changing content determination processing, it is returned to the step S11 described above, and the next slot game processing will be executed.

In the slot machine 10 of this embodiment in such a configuration, when the symbols are rearranged in the partitioned regions q11 to q53 of the display 16 by the execution of the slot game, basically a payout credit amount is determined according to their rearranged contents, and a payout of credit in the determined payout amount is made.

However, when the symbols in the partitioned regions q22, q32 and q42 on the second to fourth columns are sandwiched by the “Special” symbols rearranged in the partitioned region q12 on the first column and the partitioned region q52 on the fifth column, as shown in FIG. 1A, for example, the symbols in the partitioned regions q22, q32 and q42 on the second to fourth columns will be changed to “Special” symbols, as shown in FIG. 1B.

Then, in this unit game, a payout credit amount corresponding to a case of having five “Special” symbols rearranged (10× bet credit amount) will be determined according to the payout table stored in the ROM 108, and the payout of credit in the determined payout amount will be made.

Consequently, even when the symbols are rearranged in the partitioned regions q11 to q53 of the display 16, if the symbols in the partitioned regions q21 to q43 on the second to fourth columns are sandwiched by the “Special” symbol rearranged in the partitioned regions q11 to q13 on the first column and the “Special” symbol rearranged in the partitioned regions q51 to q53 on the fifth column, a result of this slot game is not ascertained yet, and after the symbols in the partitioned regions q21 to q43 on the second to fourth columns which are sandwiched by the “Special” symbols are changed to “Special” symbols, a result of this slot game is ascertained.

For this reason, it is possible to make a novel effect display filled with hereto unavailable changes in such a manner that there are cases where the result of this slot game is not ascertained immediately, depending on the contents of the symbols rearranged in the partitioned regions q11 to q53 of the display 16. In this way, it becomes possible to provide a new entertainment quality in the slot machine 10 and its playing method.

Also, in the slot machine 10 of this embodiment, when the symbol content changing condition is realized during the slot game, the contents of the symbols rearranged in the partitioned regions q11 to q13 and q51 to q53 on the first and fifth columns are changed. That is, the CPU 106 is configured to set contents of rearrangement candidate symbols to be rearranged in some of partitioned regions in a next game or subsequent unit games to contents different from the rearrangement candidate symbols rearranged in the some of partitioned regions in the unit game for this time, by a content change of the video display of the liquid crystal panel, in conjunction with a realization of the symbol content changing condition.

Consequently, for the “Special” symbols which only had a possibility of being rearranged one in the partitioned regions q11 to q13 on the first column and one in the partitioned regions q51 to q53 on the first column before the change as shown in FIG. 1A, it is possible to generate a possibility of being rearranged in all of the partitioned regions q11 to q13 on the first column and the partitioned regions q51 to q53 on the fifth column simultaneously, for example.

Then, when the “Special” symbols are rearranged in all of the partitioned regions q11 to q13 on the first column and the partitioned regions q51 to q53 on the fifth column simultaneously, all of the symbols rearranged in the partitioned regions q21 to q43 on the second to fourth columns are going to be sandwiched by the “Special” symbols rearranged in the partitioned regions q11 to q13 on the first column and the “Special” symbols rearranged in the partitioned regions q51 to q53 on the fifth column.

As a result, the display content of the display 16 will be changed such that all of the symbols in the partitioned regions q21 to q43 on the second to fourth columns which are sandwiched by the “Special” symbols are changed to “Special” symbols, as shown in FIG. 11. In this way, it becomes possible to receive the payout of such a large amount of credit as 100× bet credit amount according to the payout table stored in the ROM 108.

For this reason, it is possible to increase a player's interest with respect to the slot game and make a novel effect display filled even more with hereto unavailable changes. In this way, it becomes possible to provide a new entertainment quality in the slot machine 10 and its playing method.

Note that, in the embodiment described above, an exemplary case of using a configuration in which the “Special” symbols are rearranged only in the partitioned regions q11 to q13 and q51 to q53 on the first and fifth columns has been described. However, it is also possible to modify the content of the embodiment described above to use a configuration in which the “Special” symbols are also rearranged on the partitioned regions q31 to q33 on the third column as well.

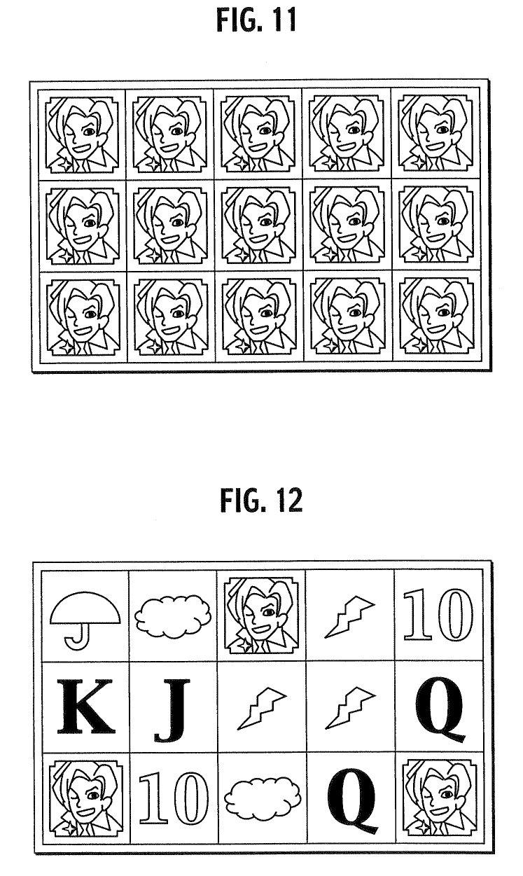

In the case of the modified embodiment in such a configuration, as a result of rearranging symbols in the partitioned regions q11 to q53 of the display 16, there arises a case where three “Special” symbols are rearranged in the partitioned region q13 on the first column, the partitioned region q31 on the third column, and the partitioned region q53 on the fifth column, as shown in FIG. 12.

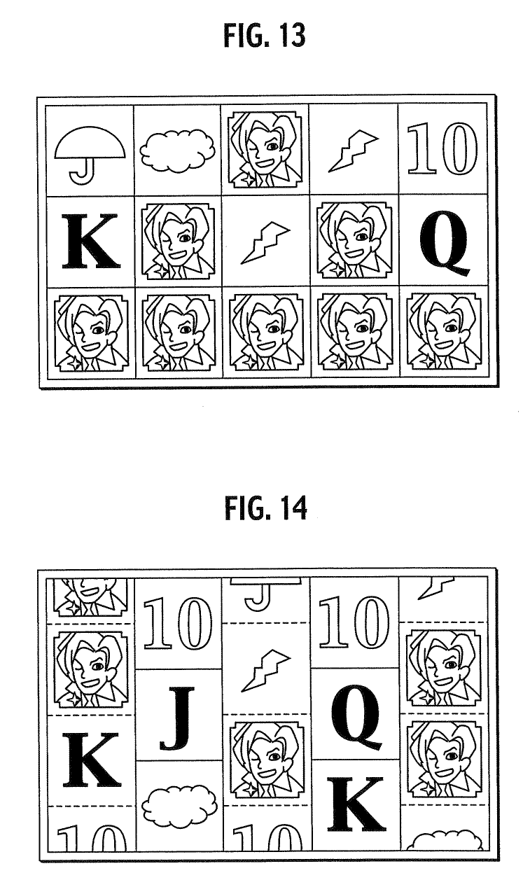

In this case, by the processing of the step S17 and the step S18 of FIG. 6, the symbols in the partitioned regions q23, q33 and q43 which are sandwiched by the two “Special” symbols in the partitioned region q13 and the partitioned region q53 will be changed to “Special” symbols, as shown in FIG. 13. In addition to that, the symbol in the partitioned region q22 which is sandwiched by the two “Special” symbols in the partitioned region q13 and the partitioned region q31 and the symbol in the partitioned region q42 which is sandwiched by the two “Special” symbols in the partitioned region q31 and the partitioned region q53 will be changed to “Special” symbols,

Also, when it is judged that the symbol content changing condition is realized by the processing of the step S20 of the slot game processing of FIG. 6, in addition to the weighting data in the ROM 108 corresponding to the partitioned regions q11 to q13 and q51 to q53 on the first and fifth columns, the weighting data in the ROM 108 corresponding to the partitioned regions q31 to q33 on the third column is also changed from the default weighting data to the other weighting data. Then, rearrangement candidate symbols for which a frequency of appearance of each type of symbol is different in proportion to a level of a probability for being rearranged in the partitioned regions q11 to q13, q31 to q33, and q51 to q53 on the first, third, and fifth columns will be displayed in the partitioned regions q11 to q13, q31 to q33, and q51 to q53 on the first, third, and fifth columns, according to the weighting data after the change.

The rearrangement candidate symbols after changing the weighting data can be displayed on the display 16 in forms of rotation reels straddling over the partitioned regions q11 to q13 on the first column, the partitioned regions q31 to q33 on the third column, and the partitioned regions q51 to q53 on the fifth column, as shown in FIG. 14, for example.

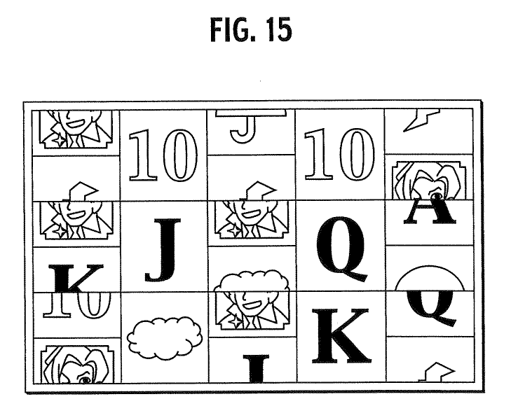

Else, for each of the partitioned regions q11 to q13, q31 to q33, and q51 to q53 on the first, third, and fifth columns, a rearrangement candidate symbol can be displayed in a form of being scrolled up or down, for example, sequentially in each of the partitioned regions q11 to q13, q31 to q33, and q51 to q53 on the first, third, and fifth columns of the display 16, as shown in FIG. 15.

In the slot machine 10 of the modification of this embodiment in such a configuration, it also becomes possible to provide a new entertainment quality in the slot machine 10 and its playing method.

Note that, in the slot machine 10 of the embodiment described above and its modification, the processing of the step S20 and the step S21 in the slot game processing to be executed by the CPU 106 may be omitted.

Also, in the embodiment described above and its modification, the rearrangement of symbols in the partitioned regions q11 to q53 of the display 16 is realized by a display of a liquid crystal panel provided in the display 16.

However, it is also possible to use a configuration in which the display 16 is formed by a transparent material, and the rearrangement of symbols in the partitioned regions q11 to q53 is realized by a rotation reel device arranged behind the display 16.

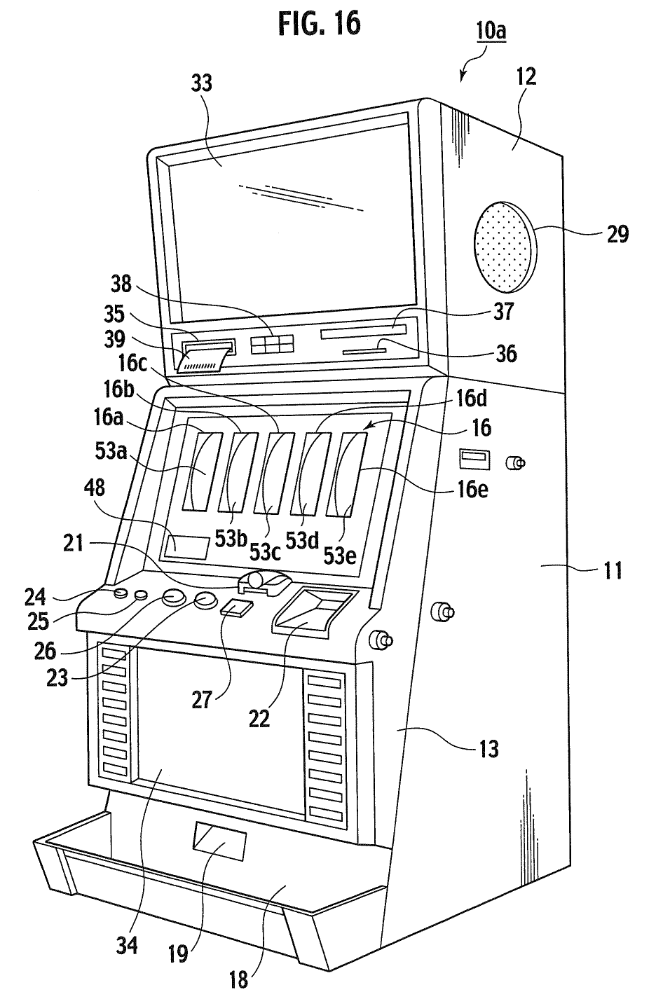

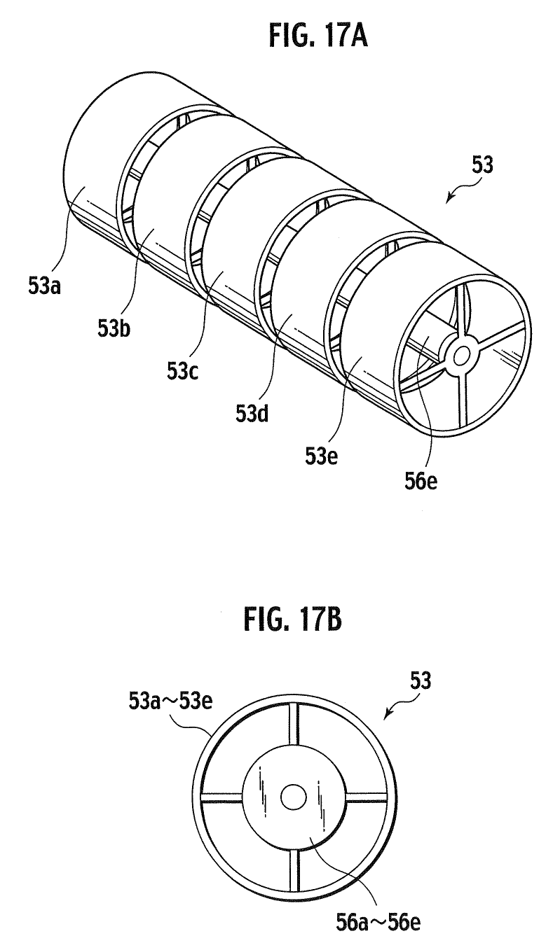

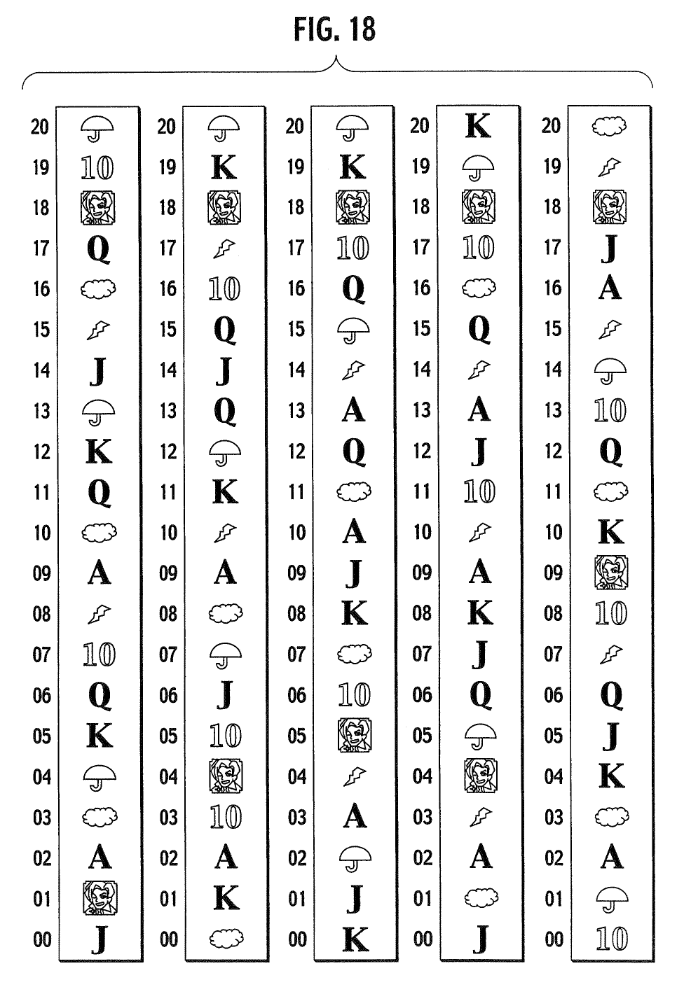

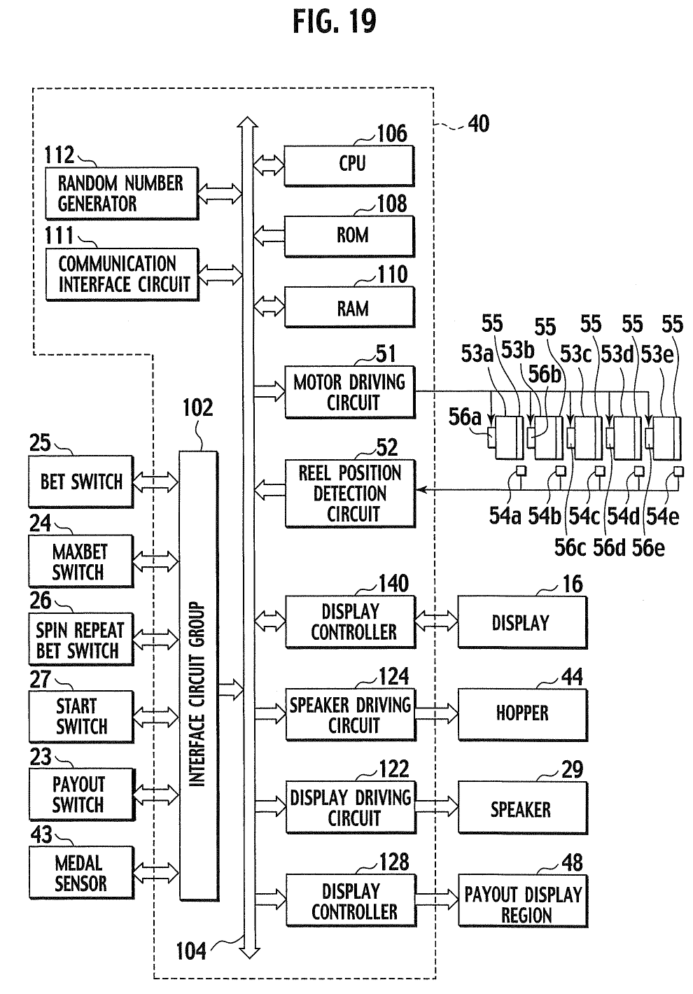

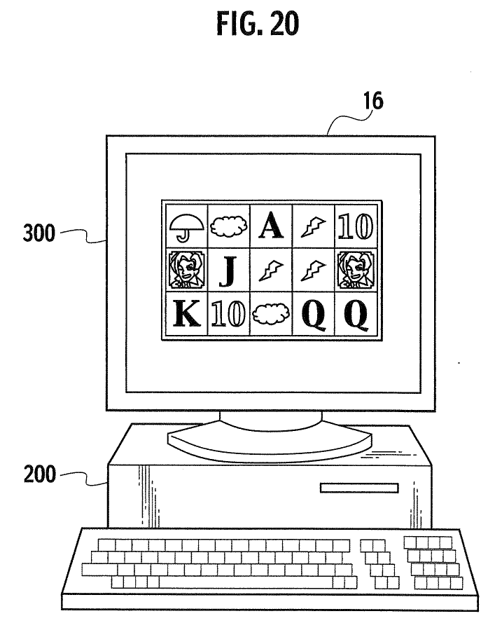

In the following, a slot machine according to the second embodiment of the present invention in which the rearrangement of symbols is realized by a rotation reel device will be described. FIG. 16 is a perspective view of a slot machine according to the second embodiment of the present invention. FIG. 17A is a perspective view showing a rotation reel device of a slot machine according to the second embodiment of the present invention. FIG. 17B is a side view showing a rotation reel device of a slot machine according to the second embodiment of the present invention. FIG. 18 is an explanatory diagram showing a schematic configuration of symbols arranged on circumferential faces of rotation reels of a slot machine according to the second embodiment of the present invention. FIG. 19 is a block diagram showing a control circuit of a slot machine according to the second embodiment of the present invention.

As shown in FIG. 16, in a slot machine 10a of this embodiment, windows 16a to 16e to be always transparently displayed are provided on the display 16 in correspondence to the first to fifth columns. Then, inside the cabinet 11, a rotation reel device 53 is arranged to be located behind the display 16.

The rotation reel device 53 has five rotation reels 53a to 53e corresponding to the windows 16a to 16e of the display 16, as shown in FIG. 17A. Also, as shown in FIG. 17B, the rotation reel device 53 has driving motors 56a to 56e formed by stepping motors to rotate the rotation reels 53a to 53e, respectively. Also, the rotation reel device 53 has sensors 54a to 54e (see FIG. 19) for reading a bar code and counting a number of slits that have passed, in order to detect a rotation, a stopping, and a stopped rotation position of each of the rotation reels 53a to 53e.

On a circumferential face of each of the rotation reels 53a to 53e, 21 symbols are laid out at equal intervals, as shown in FIG. 18. Among them, on the rotation reels 53a and 53e corresponding to the windows 16a and 16e (the first and fifth columns) of the display 16, nine types of symbols including “A (Ace card)”, “K (King card)”, “Q (Queen card)”, “J (Jack card)”, “10 (10 card)”, “Umbrella”, “Lightning”, “Cloud”, and “Special (man's face)” are laid out in prescribed patterns. Also, on the rotation reels 53b to 53d corresponding to the windows 16b to 16d (the second to fourth columns) of the display 16, the nine types of symbols described above are laid out in prescribed patterns.

Then, in the slot machine 10a of this embodiment, three consecutive symbols among 21 symbols laid out on the circumferential face of the corresponding one of the rotation reels 53a to 53e can be made visible to a player, through each of the windows 16a to 16e of the display 16. In other words, the windows 16a to 16e of the display 16 constitute the corresponding three partitioned regions q11 to q13, q21 to q23, q31 to q33, q41 to q43, and q51 to q53 in the row direction on the first to fifth columns.

Also, in the slot machine 10a of this embodiment, as shown in FIG. 19, a motor driving circuit 51 for driving the driving motors 56a to 56e of the rotation reel device 53, and a reel position detection circuit 52 for detecting a rotation, a stopping, and a stopped position of each of the rotation reels 53a to 53e according to outputs of the sensors 54a to 54e of the rotation reel device 53, are provided in the controller 40.

The sensors 54a to 54e are arranged to be facing with margin portions 55 secured adjacent to symbol layout regions on the circumferential faces of the corresponding rotation reels 53a to 53e. Then, each of the sensors 54a to 54e can detect a rotation, a stopping, and a stopped position of each of the rotation reels 53a to 53e by detecting an identifier such as a bar code laid out in the margin portion 55 in correspondence to each symbol. Note that, for the detection of the identifier by the sensors 54a to 54e, various types of known schemes such as an optical one or a magnetic one can be utilized.

In the slot machine 10a of this embodiment in such a configuration, the processing for the dynamically changing display of symbols at the step S15 and the processing for changing symbols sandwiched by “Special” symbols to “Special” symbols at the step S17 in the slot game processing of FIG. 6 are carried out by rotating and stopping the rotation reels 53a to 53e of the rotation reel device 53 by driving the driving motors 56a to 56e by the motor driving circuit 51.

Also, in the slot machine 10a of this embodiment, the processing for judging whether there is a win or not according to the symbols rearranged in the partitioned regions q11 to q53 at the step S18 of the slot game processing of FIG. 6 is carried out according to the detection result of a rotation, a stopping and a stopped position of each of the rotation reels 53a to 53e detected by the reel position detection circuit 52 by using the outputs of the sensors 54a to 54e.

Note that the layout and the contents of the symbols on the rotation reels 53a to 53e of the rotation reel device 53 are fixed, so that the processing of the step S20 and the step S21 in the slot game processing of FIG. 6 will not be carried out in the slot machine 10a of this embodiment.

In the slot machine 10a of this embodiment in such a configuration, it also becomes possible to provide a new entertainment quality in the slot machine 10a and its playing method.

As a modification of the second embodiment, symbols may be rearranged and displayed similar to the modification of the first embodiment as shown in FIG. 12.

In the above, a slot machine and a control method of a slot machine of the present invention have been described on bases of the embodiments shown in the figures, but the present invention is not limited to these, and a configuration of each unit can be replaced by an arbitrary configuration which has the similar functions.

For example, in the embodiments described above, the case where the partitioned regions of the display 16 have 15 partitioned regions q11 to q53 formed by five columns and three rows has been described, but a number of the partitioned regions arranged in a matrix shape that constitute the display is arbitrary in both the column direction and the row direction.

Also, in the embodiments described above and their modifications, the case of applying the present invention to a dedicated slot machine has been described. However, the present invention is also applicable to a gaming system for displaying a game screen on a monitor 300 according to a program installed into a personal computer 200.

In that case, the functions of the controller 40 and the like of FIG. 4 are incorporated into the personal computer 200, and the display 16 similar to that shown in FIG. 2 will be displayed on the monitor 300 connected to this personal computer 200. Then, on the displayed display 16, the personal computer 200 will realize the display similar the display 16 in the slot machine 10 of the first embodiment described above and its modification, on the display 16 of the monitor 300, by executing the installed program.

Even in such a gaming machine of the simulation game style, it also becomes possible to provide a new entertainment quality in the gaming machine and its playing method by practicing the present invention.

In addition, in the detailed description above, the characteristic portions are mainly described in order to make the present invention easily understandable. The present invention is not limited to the embodiments described in the detailed description above, and can be applied to the other embodiments, and its range of application is wide. Also, the terms and the terminology used in the present specification are used only for the purpose of explaining the present invention precisely, and not used for the purpose of limiting the interpretation of the present invention. Also, for those skilled in the art, it should be easy to contemplate other configurations, systems, methods, etc., that are contained in the concept of the present invention, from the content of the invention described in the present specification. Consequently, the description of the scope of claims should be construed as containing equivalent configurations within a range of not deviating from a range of the technical ideas of the present invention. Also, the purpose of the abstract is to make it possible for the patent office, the general public organizations, and technicians and the like who belong to the present technical field and who are not thoroughly familiar with patent and law terms or specialized terms, to quickly judge the technical content and its essence of the present application by a simple search. Consequently, the abstract is not intended to limit the scope of the invention which should be evaluated by the description of the scope of claims. Also, in order to sufficiently understand the purpose of the present invention and the effects specific to the present invention, they should preferably be interpreted by sufficiently referring to the documents and the like that are already disclosed in public.

Also, the detailed description above contains the processing to be executed by a computer. The explanations and expressions in the above are described for the purpose of facilitating the most efficient understanding by those skilled in the art. In the present specification, each step used in deriving one result should be understood as a processing without a self-contradiction. Also, at each step, transmission and reception, recording, etc., of electric or magnetic signals will be carried out. In the processing at each step, such signals are expressed by bits, values, symbols, letters, terms, numbers, etc., but it should be noted that they are used simply because they are convenient for the purpose of explanation. Also, there are cases where the processing at each step is described by an expression common to the human behavior, but the processing described in the present specification is to be executed by various devices in principle. Also, the other configuration required in carrying out each step will be obvious from the above description.

What is claimed is:

1. A gaming machine comprising:
a display on which a rearrangement of symbols arranged in a plurality of partitioned regions that are arranged in a matrix shape formed by a plurality of columns and a plurality of rows is carried out in each unit game; and
a controller configured to
(a) rearrange the symbols in the plurality of partitioned regions in a unit game, and
(b) when both of symbols at both ends of a symbol sequence formed by a plurality of symbols rearranged along one of a column direction, a row direction, and an oblique direction composed from the column direction and the row direction are prescribed symbols, change all symbols sandwiched by the prescribed symbols in the symbol sequence to the prescribed symbols before a start of a next unit game.

2. The gaming machine as described in claim 1, wherein the controller is also configured to add an award in a case where all of the plurality of symbols in the symbol sequence are the prescribed symbols, to an award with respect to this unit game, when both of the symbols at both ends of the symbol sequence are the prescribed symbols in this unit game.

3. A gaming machine comprising:
a display on which a rearrangement of symbols arranged in a plurality of partitioned regions is carried out in each unit game, by a video display of a liquid crystal display which is provided over the plurality of partitioned regions that are arranged in a matrix shape formed by a plurality of columns and a plurality of rows; and
a controller configured to
(a) rearrange the symbols in the plurality of partitioned regions by changing a content of the video display, in a unit game, and
(b) when both of symbols at both ends of a symbol sequence formed by a plurality of symbols rearranged along one of a column direction, a row direction, and an oblique direction composed from the column direction and the row direction are prescribed symbols, change all symbols sandwiched by the prescribed symbols in the symbol sequence to the prescribed symbols by changing a content of the video display, before a start of a next unit game.

4. The gaming machine as described in claim 3, wherein the controller is also configured to add an award in a case where all of the plurality of symbols in the symbol sequence are the prescribed symbols, to an award with respect to this unit game, when both of the symbols at both ends of the symbol sequence are the prescribed symbols in this unit game.

5. The gaming machine as described in claim 3, wherein, in the unit game, the controller is configured to
rearrange each symbol selected from first candidates of a plurality of symbols including a prescribed symbol by changing a content of the video display, in some of partitioned regions including partitioned regions on rows located at both ends in the column direction of the plurality of partitioned regions or some of partitioned regions including partitioned regions on columns located at both ends in the row direction of the plurality of partitioned regions, among the plurality of partitioned regions, and
rearrange each symbol selected from second candidates of a plurality of symbols not including the prescribed symbol by changing a content of the video display, in other partitioned regions other than the some of partitioned regions among the plurality of partitioned regions.

6. The gaming machine as described in claim 5, wherein the some of partitioned regions include partitioned regions on rows other than both ends in the column direction, or partitioned regions on columns other than both ends in the row direction.

7. The gaming machine as described in claim 5, wherein the controller is configured to change contents of the first candidates of this unit game to different contents for a next game or subsequent unit games by changing a content of the video display in a prescribed changing condition.

8. The gaming machine as described in claim 7, wherein the controller is configured to display a notification image for notifying the first candidates after a change of contents on the liquid crystal display, before a start of the next unit game, after changing the contents of the first candidates of this unit game to the different contents for the next game or subsequent unit games in the prescribed changing condition.

9. A gaming machine comprising:
a display on which a rearrangement of symbols arranged in a plurality of partitioned regions that are arranged in a matrix shape formed by a plurality of columns and a plurality of rows is carried out in each unit game, by rotation and stopping of a plurality of mechanical reels corresponding to the plurality of columns and the plurality of rows; and
a controller configured to
(a) rearrange the symbols in the plurality of partitioned regions by rotation and stopping of the mechanical reels, in a unit game, and
(b) when both of symbols at both ends of a symbol sequence formed by a plurality of symbols rearranged along one of a column direction, a row direction, and an oblique direction composed from the column direction and the row direction are prescribed symbols, change all symbols sandwiched by the prescribed symbols in the symbol sequence to the prescribed symbols by rotation and stopping of the mechanical reels corresponding to partitioned regions in which the symbols sandwiched by the prescribed symbols in the symbol sequence are rearranged, before a start of a next unit game.

10. The gaming machine as described in claim 9, wherein the controller is also configured to add an award in a case where all of the plurality of symbols in the symbol sequence are the prescribed symbols, to an award with respect to this unit game, when both of the symbols at both ends of the symbol sequence are the prescribed symbols in this unit game.

11. A method of playing a gaming machine, the method comprising the steps of:
rearranging symbols in a plurality of partitioned regions that are arranged in a matrix shape formed by a plurality of columns and a plurality of rows, in each unit game; and
when both of symbols at both ends of a symbol sequence formed by a plurality of symbols rearranged along one of a column direction, a row direction, and an oblique direction composed from the column direction and the row direction are prescribed symbols, changing all symbols sandwiched by the prescribed symbols in the symbol sequence to the prescribed symbols before a start of a next unit game.

12. The method of playing a gaming machine as described in claim 11, the method further comprising the step of adding an award in a case where all of the plurality of symbols in the symbol sequence are the prescribed symbols, to an award with respect to this unit game, when both of the symbols at both ends of the symbol sequence are the prescribed symbols in this unit game.
